(19) United States
(12) Patent Application Publication
(10) Pub. No.: US 2026/0151729 A1
(43) Pub. Date: Jun. 4, 2026

(54) MEMBRANE-BASED DEHUMIDIFICATION SYSTEM, THERMALLY-INSULATIVE SELECTIVE MEMBRANE, AND METHOD

(71) Applicant: Purdue Research Foundation, West Lafayette, IN (US)

(72) Inventors: David E. M. Warsinger, Carmel, IN (US); Md Ashiqur Rahman, West Lafayette, IN (US)

(21) Appl. No.: 19/407,759

(22) Filed: Dec. 3, 2025

Related U.S. Application Data
(60) Provisional application No. 63/727,610, filed on Dec. 3, 2024.

(51) Int. Cl. B01D 53/26; B01D 53/22; B01D 53/28; B01D 69/02; B01D 69/10; B01D 71/52; B01D 71/56; B01D 71/80

(52) U.S. Cl. CPC B01D 53/268; B01D 53/228; B01D 53/28; B01D 69/02; B01D 69/107; B01D 69/108; B01D 71/5211; B01D 71/56; B01D 71/80; B01D 2257/80; B01D 2325/04; B01D 2325/36

(57) ABSTRACT

Membrane-based dehumidification systems, thermally-insulative selective membranes, and associated methods. The membrane-based dehumidification systems include thermally-insulative selective membranes that help maintain water vapor partial pressure difference across the selective membrane by maintaining a temperature differential across the membrane. The selective membrane includes an active layer disposed on a support layer. The support layer may be made of a mixture of polyvinylidene fluoride and a reduced graphene oxide filler to improve the thermal insulative properties of the selective membrane and insulate the active layer from a temperature differential between a feed air side and a permeate air side of the selective membrane.

### CROSS-REFERENCE TO RELATED APPLICATIONS

This application claims the benefit of provisional U.S. Patent Application No. 63/727,610 filed Dec. 3, 2024, the contents of which are incorporated herein by reference.

### STATEMENT REGARDING FEDERALLY SPONSORED RESEARCH

This invention was made with government support under contract number DE-EE0010199 awarded by United States Department of Energy. The government has certain rights in the invention.

### BACKGROUND OF THE INVENTION

The invention relates generally to membrane-based dehumidification systems, thermally-insulative selective membranes, and associated methods.

Air dehumidification in enclosed spaces, such as in buildings (e.g., homes, offices, commercial and industrial buildings), passenger compartments (e.g., in automobiles, trains, marine vehicles, and aerospace vehicles), machinery (e.g., within enclosed machinery or computer equipment compartments), and any other enclosed environment in which atmospheric control may be desired, is useful for many reasons. Currently, most dehumidification systems fall into one of three categories: vapor compression refrigeration (VCR) systems, desiccant-based dehumidification systems, and membrane-based dehumidification systems. Conventional vapor compression refrigeration dehumidification systems are most frequently used for larger-scale spaces, such as buildings and vehicle passenger compartments. These systems operate below the dew point temperature to remove the water vapor from an air stream by water condensation. These water condensation processes are energy-intensive, thereby having high energy costs. Desiccant-based dehumidification systems adsorb and/or absorb water vapor from the moist air. However, these systems also have high energy costs for regeneration, as well as other disadvantages.

Membrane-based dehumidification systems use selective (semi-permeable) membranes, which allow water vapor transport across the membrane but blocks air movement across the membrane, to avoid phase change and typically have lower energy requirements in comparison to the VCR and desiccant-based systems. One type of a membrane-based dehumidification system is vacuum membrane dehumidification systems, in which a vacuum pump/compressor on the permeate side creates the water vapor partial pressure differences across a selective membrane and pulls out the water vapor from the feed side isothermally. However, the use of compressor pumps also increases the energy usage and associated costs of these systems.

Another type of membrane-based dehumidification system is known as a passive membrane dehumidification (PMD) system, which takes advantage of water vapor pressure differentials between a feed stream and a permeate stream across a selective membrane to remove moisture. Due to their passive nature, these systems can have lower energy costs. However, in these systems, characteristics of the selective membrane can have a significant impact on the systems overall functionality and efficiency. One known selective membrane for use in membrane dehumidification systems is disclosed in Fix et al., “Enhancing Membrane-Based Air Dehumidification Through Non-Isothermal Operation,” International Refrigeration and Air Conditioning Conference, Paper 2318 (2022), which discloses a selective membrane having alternating layers of thin, dense selective selectively-permeable layers made of PEBAX 1657 mixed with graphene oxide (“GO”) and a highly porous non-permeable substrate layers of PVDF. The PEBAX 1657/graphene oxide selectively-permeable layers allow water vapor to permeate therethrough but not air. The PVDF substrate layers provide structural integrity for the overall membrane morphology but do not allow water and air to permeate. However, the current passive membrane dehumidification systems cannot efficiently reject humidity without losing heat due to poor thermal insulation across the selective membrane.

Therefore, it would be desirable to have a selective membrane that can improve the energy efficiency of membrane-based dehumidification systems even more.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, membrane-based dehumidification systems, thermally-insulative selective membranes, and methods related thereto.

According to a nonlimiting aspect, a membrane-based dehumidification system includes a thermally-insulative selective membrane separating a feed stream of moist air to be dehumidified and a permeate stream of air. Water vapor partial pressure difference across the selective membrane at least partly urges water vapor in the feed stream to migrate across a thickness dimension of the selective membrane to the permeate stream. The selective membrane may include a porous thermally-insulating support layer and a hydrophilic active layer. The hydrophilic active layer may be disposed on a side of the support layer. The support layer may include a mixture of polyvinylidene fluoride, polytetrafluoroethylene (PTFE), polyacrylonitrile (PAN), polyethersulfone (PES), and/or polysulfone (PSF), and a two-dimensional layered nanomaterial filler chosen from the group consisting of a reduced graphene oxide, a graphitic or graphene aerogel (GA), a silica aerogel, graphene, and MXenes.

According to another nonlimiting aspect, a thermally-insulative selective membrane for a membrane-based dehumidification system includes a porous thermally-insulating support layer and a hydrophilic active layer. The porous thermally-insulating support layer may be disposed on a side of the hydrophilic active layer. The support layer may include a mixture of polyvinylidene fluoride, polytetrafluoroethylene (PTFE), polyacrylonitrile (PAN), polyethersulfone (PES), and/or polysulfone (PSF), and a two-dimensional layered nanomaterial filler chosen from the group consisting of a reduced graphene oxide, a graphitic or graphene aerogel (GA), a silica aerogel, graphene, and MXenes.

According to yet another nonlimiting aspect, a method of making a thermally-insulative selective membrane having an active layer and a support layer for a membrane-based dehumidification system is provided. The method includes forming the support layer from a first solution of polyvinylidene fluoride, polytetrafluoroethylene (PTFE), polyacrylonitrile (PAN), polyethersulfone (PES), and/or polysulfone (PSF), and a two-dimensional layered nanomaterial filler chosen from the group consisting of a reduced graphene oxide, a graphitic or graphene aerogel (GA), a silica aerogel, graphene, and MXenes. The active layer may be formed from a second solution of polyether-block-amide thermoplastic elastomer. The active layer may be secured to the support layer to form the thermally-insulative selective membrane such that the support layer provides structural support to the active layer.

Technical aspects of thermally-insulative selective membranes and membrane-based dehumidification systems as described above preferably include the ability to provide a dehumidification system that is more energy efficient than at least some of the previously known dehumidification systems.

These and other aspects, arrangements, features, and/or technical effects will become apparent upon detailed inspection of the figures and the following description.

### BRIEF DESCRIPTION OF THE DRAWINGS

FIG. 1 is a diagrammatic representation of a passive membrane dehumidification system according to certain nonlimiting aspects of the invention.

FIG. 2 is a diagrammatic representation of a thermally-insulative selective membrane of the system in FIG. 1 according to certain nonlimiting aspects of the invention.

FIGS. 3A and 3B represent steps in an example process of making the thermally-insulative selective membrane of FIG. 2 according to certain nonlimiting aspects of the invention.

FIGS. 4A and 4B are enlarged SEM images of portions of selective membranes made in accordance with the processes shown in FIGS. 3A and 3B. FIG. 4A is an SEM image of a PVDF/rGO/PEBAX/GO/050 membrane. The dotted lines indicate the active dense PEBAX/GO layer coating on PEBAX/rGO support layer. FIG. 4B is an SEM image of the PVDF/rGO/PEBAX/GO/050 membrane at higher magnification.

FIG. 5A contains optical microscopy images that show a fabricated support layer in which PVDF and rGO particles are visualized (top image) and the fabricated active layer in which PEBAX and GO are visualized (bottom image).

FIGS. 5B and 5C contain graphs plotting FTIR and Raman spectroscopy of rGO granules, PVDF and PVDF/rGO/0.50 support layers, and a PEBAX/GO active layer.

FIG. 5D contains a bar graph plotting through-plane thermal conductivity of support layers having different rGO concentrations.

FIG. 5E is a graph plotting a pore size distribution comparison between PVDF and PVDF/rGO/0.50 membranes using CFP.

FIG. 5F contains a cross-sectional SEM image and a corresponding segmented image obtained via image processing of a fabricated insulating membrane.

FIG. 5G contains a 3D Voronoi fiber network diagram to construct the hierarchical porous structure (dimensions: 42×42×19.4 mm3) of a fabricated insulating membrane.

FIG. 5H contains XY temperature distribution plots at different positions along the thickness direction (Z=t/4, t/2, 3t/4). Boundary conditions were applied to the top (Z=0) and bottom (Z=t) planes. The effective thermal conductivity was determined employing a finite difference method on the Voronoi structure.

FIG. 6 is a schematic diagram of a passive membrane dehumidification system and testing setup used in investigations of insulative selective membranes produced in accordance with some nonlimiting aspects of the present invention.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also describes certain investigations relating to the embodiment(s) and identifies certain but not all alternatives of the embodiment(s). As nonlimiting examples, the invention encompasses additional or alternative embodiments in which one or more features or aspects shown and/or described as part of a particular embodiment could be eliminated and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Although the invention will be described hereinafter in reference to the passive membrane dehumidification systems shown in the drawings, it will be appreciated that the teachings of the invention are also generally applicable to other types of membrane-based dehumidification system, such as, but not limited to, vacuum membrane dehumidification systems, energy recovery ventilators, high temperature industrial dryers, and other dehumidification systems capable of incorporating the principles of removing moisture using a selective (semi-permeable) membrane, particularly to address the desire to improve dehumidification efficiency with minimum sensible heat loss.”.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

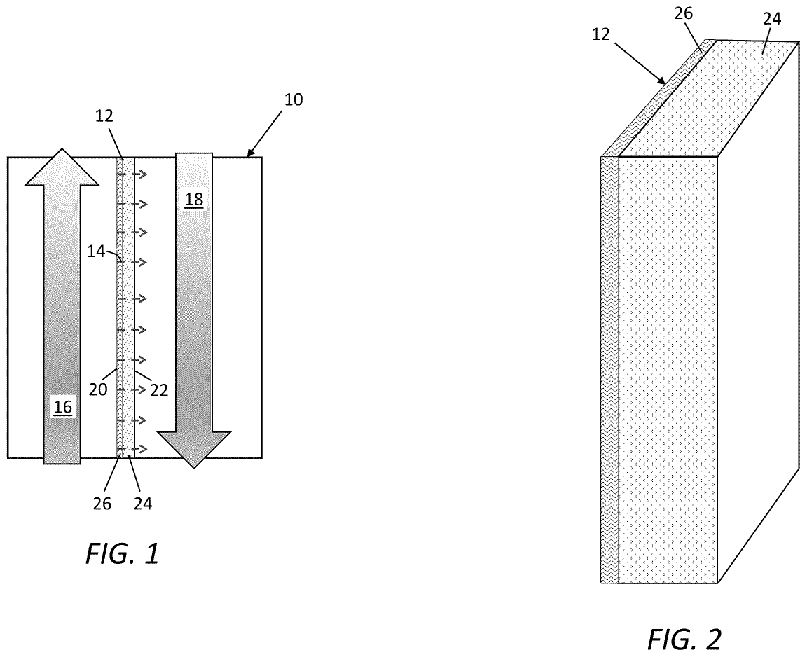

Turning now to the nonlimiting embodiments represented in the drawings, FIG. 1 depicts a selective membrane dehumidification module 10 of a membrane-based dehumidification system incorporating a thermally-insulative selective (semi-permeable) membrane 12 to separate moisture (e.g., water vapor 14) out from a moist air stream. In this example, the membrane-based dehumidification system is a passive membrane dehumidification (PMD) system, although other types of membrane-based dehumidification systems could be used. The selective membrane 12 separates a feed stream 16 of the moist air to be dehumidified from a permeate air stream 18. The feed stream 16 may be a stream of hot, humid air. The permeate air stream may be a stream of cool, dry air. In this example, the PMD system is configured for counterflow of the two air streams, with the feed stream 16 and the permeate air stream 18 moving in opposite directions along opposite sides of the selective membrane 12; however, other airflow arrangements could be configured. Specifically, the selective membrane 12 has two opposite sides a first side 20 facing and in contact with the feed stream 16 and a second side 22 facing and in contact with the permeate air stream 18. In various arrangements, the membrane-based dehumidification system may also include additional components, such as air movers, ducts, water collection systems, control systems, heaters, coolers, etc., suitable for various installation configurations if desired.

In a PMD system, a primary driving force across the selective membrane is believed to be the water vapor partial pressure difference between the feed and permeate stream. The temperature difference across the selective membrane is higher when a hot and humid feed stream is incorporated, thereby exchanging heat from one side to another through the selective membrane. Due to the increased temperature difference, the total pressure of the permeate increases, thereby significantly increasing the water vapor partial pressure. As the permeate temperature rises, the driving force decreases. Consequently, a PMD system's performance may worsen as the permeate temperature gets closer to the feed stream temperature. Based on this understanding, the inventors recognized that a selective membrane with low thermal conductivity would reduce heat loss across the membrane and therefore, would help increase the efficiency of operation of the PMD system.

In this configuration, the difference in the water vapor partial pressure across the selective membrane 12 causes water vapor in the feed stream 16 to migrate across the thickness of the selective membrane 12 from the first (feed) side 20 to the second (permeate) side 22. This is caused at least in part by the semi-permeable characteristic of the selective membrane 12, which in this configuration allows water to migrate across its thickness but substantially prevents air from migrating across its thickness. In this way, when a partial water vapor pressure difference exists between the two sides 20 and 22 of the membrane, this pressure difference will urge the water to migrate from one side to the other while simultaneously preventing the air from migrating from one side to the other. In this way, moisture in the feed stream 16 can be removed from the air in the feed stream, thereby allowing dry (er) air to exit the module 10. At the same time the moisture removed from the feed stream 16 may be removed by the permeate air stream 18, a drain, and/or other suitable removal mechanisms after the absorbed/adsorbed water has migrated across the selective membrane 12 to the second side 22. In this example, configuring the system to have the counterflow arrangement through the module 10 may provide a more even and/or effective vapor pressure differential across the entire surface and/or length (in the direction of the air flow) of the selective membrane 12, which may improve the efficiency and/or effectiveness of the dehumidification system.

As best seen in FIG. 2, the selective membrane 12 has two layers (plies) across its thickness dimension: a support layer 24 and an active layer 26. The active layer 26 is made with a semi-permeable hydrophilic material that absorbs and/or adsorbs moisture from the feed stream 16 and allows the water to migrate therethrough. The active layer 26 also prevents gases, such as air, to pass therethrough. The active layer may be made of a polyether-block-amide thermoplastic elastomer made of flexible polyether and rigid polyamide blocks, such as poly (amide-B-ethylene). In some arrangements, the active layer 26 is made with PEBAX®-1657 polyether-block-amide available from Arkema France. The active layer 26 may also include graphene oxide mixed with the polyether-block-amide. In some nonlimiting examples, the active layer 26 is has a thickness on the order of micrometers (e.g., 1-999 μm, preferably about 10 μm to about 50 μm thick) and has in-plane length and width dimensions on the order of centimeters (e.g. 1-99 cm) to meters (e.g. 1-99 m), although other dimensions may be used.

The support layer 24 is secured to one side of the active layer to provide enough structural support for the active layer to maintain the integrity of the membrane's sheet morphology because the active layer 26 is typically very thin in order to maximize water migration therethrough. For example, opposing sides of the support layer 24 and the active layer 26 facing each other may be touching and secured to each other by any suitable securement mechanism. The support layer 24 is also thermally-insulative to help maintain the temperature gradient across the thickness of the active layer 26 so as to minimize any reduction in the partial water vapor pressure differential at least partly caused by the temperature differential between the feed stream 16 (side 20) and the permeate air stream 18 (side 22). The support layer 24 is made of a porous, thermally-insulative material that allows water to migrate through its thickness from the active layer to its opposite, exterior side. The support layer 24 may be hydrophobic. In some embodiments, the support layer is made of mixture of polyvinylidene fluoride (PVDF) and a reduced graphene oxide filler (rGO). For example, the reduced graphene oxide filler may be about 0.25% to about 1% by weight of the mixture relative to the PVDF. The reduced graphene oxide filler is believed to improve the thermal insulative characteristics of the support layer 24. The support layer 24 may have a thickness of about 25 μm to about 360 μm and have in-plane length and width dimensions on the order of centimeters to meters, although other dimensions may be used.

Returning to FIG. 1, the selective membrane 12 is arranged with the active layer 26 facing the moist air to be dehumidified. In this example, the feed stream 16 and the support layer 24 face the permeate air stream 18 for water collection and/or removal. In operation, as the warm, moist feed stream 16 blows across the surface of the active layer 26, water/moisture in the feed stream air is absorbed/adsorbed by the active layer. Simultaneously, the cooler, drier permeate air stream causes a partial water vapor pressure differential between the two sides 20, 22 that drives the absorbed/adsorbed water through the thickness of the membrane from the first side 20 to the second side 22. Simultaneously, the thermal insulative characteristic of the support layer 24 also reduces or prevents the temperature of the side of the active layer 26 facing toward the permeate air stream from equalizing with the temperature of the feed stream side, thereby helping to maintain the partial water vapor pressure differential.

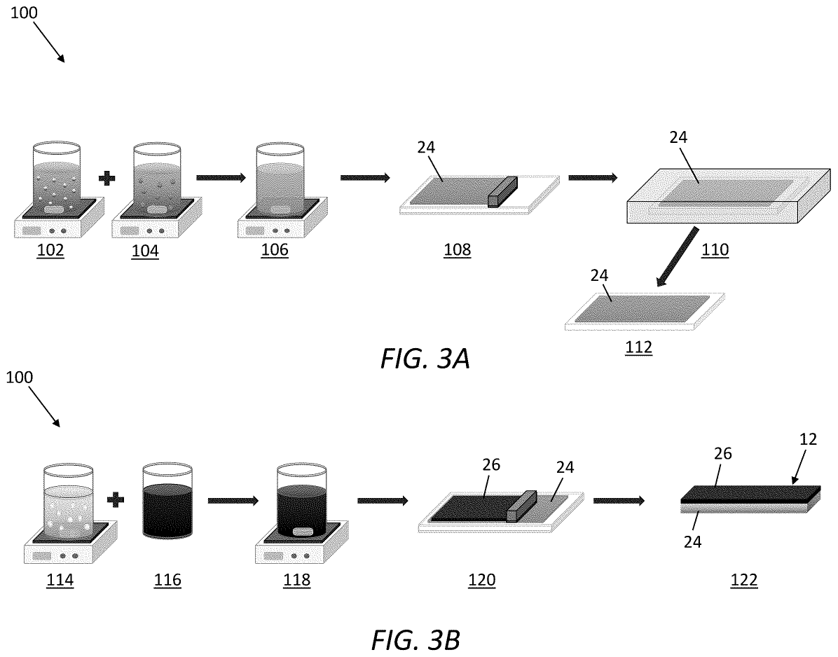

FIGS. 3A and 3B illustrate a nonlimiting example method 100 of fabricating the selective membrane 12. FIG. 3A depicts the fabrication of the support layer 24 using casting and phase inversion method. At 102, 10% PVDF is thoroughly mixed with a solvent, such as dimethylformamide (DMF). Next at 104, rGO is added to the DMF-PVDF solution (by adding a DMF-rGO solution) and thoroughly mixed while being heated. The solution was mixed at 80° C. and 600 rpm for 45 minutes to form the support layer solution at 106. Then at 108, the support layer solution was cast onto a glass casting plate using a casting knife to form the support layer 24. At 110, the support layer 24 was then subjected to a deionized (DI) water bath for 5 mins. Later, the fabricated support layer 24 was transferred to another DI water bath and kept for 24 hours. After that, at 112 the support layer 24 was dried for another 24 hours inside a controlled oven at a temperature of 25° C. and relative humidity of 35%. During the drying, any free solvent may substantially evaporate out of the support layer 24. For some investigations leading to the invention, different formulations of the PVDF-DMF-rGO mixture with 0%, 0.25%, 0.5%, 0.75%, and 1% of rGO relative to PVDF were prepared. For purposes of convenient notation hereinafter, the different formulations of the support layer 24 are sometimes denoted according to the convention PVDF/rGO/rGO-concentration %, where the concentration denotes the rGO % concentration (e.g., PVDF/rGO/0.25 corresponding to the 0.25% concentration rGO).

FIG. 3B depicts the creation and coating of the active layer 26 onto the support layer 24. At 114, polyether-block-amide thermoplastic elastomer is mixed with an aqueous-based solvent to form a precursor solution. In this example, 1.5 g of PEBAX® 1657 pellets were mixed in 50 mL a water/ethanol solution (30/70 by volume) and thoroughly mixed at 80° C. and 800 rpm for 2.5 hours to form a first precursor solution. Next at 116, graphene oxide (GO) is mixed into the precursor solution. In this example, the precursor solution was mixed with 10 mL of GO solution (0.4% by weight in water) to form a PEBAX/GO solution. Then at 120, the PEBAX/GO solution was cast onto one side of the PVDF/rGO support layer 24 using the casting blade to form the selective membrane 12 cast directly onto the top surface of the support layer 22. Then at 122, after sufficient drying time, the selective membrane 12 may be removed from the casting plate. The steps 114-118 for mixing the PEBAX/GO solution may be performed any time before, during, and/or after the steps 102-112 for creating the support layer 22. In some arrangements, the steps 114-118 are performed at a time such that the support layer 22 is ready to have the PEBAX/GO solution applied thereon before the PEBAX/GO solution dries out or otherwise is no longer suitable for applying onto the finished support layer.

Other manufacturing methods may be used. For example, the support layer 24 and/or the active layer 26 may be made by different casting methods, such as dispersion casting, or by methods other than the casting, such as extrusion, calendaring, and/or spray deposition. In addition, the support layer 24 and the active layer 26 may be secured together by mechanism other than the direct casting example, such as with welding, adhesives, or mechanical fasteners.

For purposes of convenient notation hereinafter, the selective membrane 12 formed with the various formulations of the active layer 24 can also be denoted according to the convention PVDF/rGO/PEBAX/GO/rGO %, where rGO % is the appropriate corresponding concentration of the rGO in the active layer (e.g., PVDF/rGO/PEBAX/GO/0.50 corresponding to the 0.5% concentration rGO).

In investigations leading to the present invention(s), various experimental selective membranes having a highly thermally-insulating support layer of polyvinylidene difluoride (PVDF) with varying reduced graphene oxide (RGO) concentrations and a hydrophilic selective layer (or active layer) of PEBAX 1657 and graphene oxide (GO) were fabricated using the casting and phase inversion method described previously herein. Testing showed that the thermal conductivity of the membrane support layer 24 decreased from 0.07 W/m-K to 0.03 W/m-K when rGO loading increased from 0% to 0.5%. Scanning electron microscopy (SEM) and capillary flow porometry (CFP) were used to measure the pore size and porosity of the fabricated membranes 24 and 26. Additionally, Fourier transform infrared (FTIR) spectroscopy, water vapor permeance, and N2 permeance tests were performed to characterize the functional groups and membrane properties. Finally, the most thermally-insulating selective membrane was compared with a control selective membrane having no (0%) rGO loaded into the support layer under the effect of relative humidity change, temperature, and mass flow variation. The thermally-insulating selective membrane outperformed the control selective membrane at a temperature higher than 34° C. At 40° C. and 50% relative humidity, the insulating membrane exhibited a 43% higher dehumidification performance than the control selective membrane.

In the course of the investigations, thermally-insulating support layers of PVDF and different rGO concentrations were fabricated using the casting and phase inversion method as described previously herein. A selective PEBAX/GO composite coating was cast on one side of the support layer as also described previously herein. The dehumidification performances were then compared between the thermally-insulating membranes (0.25%-1.0% rGO) and control membrane (without any filler in the support layer, PVDF/rGO/000), and different characterizations were performed to analyze the membrane properties.

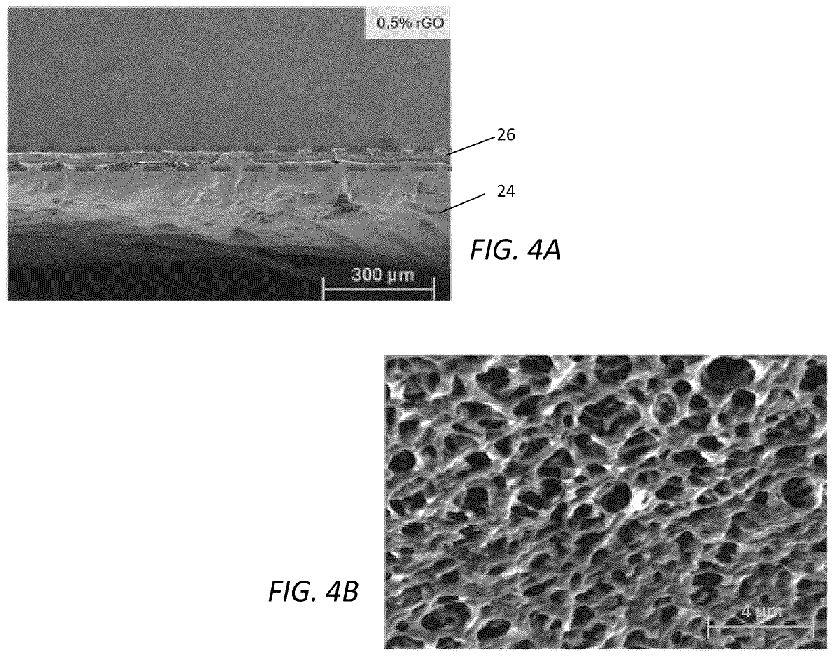

With reference to FIGS. 4A and 4B, the surface morphology of the fabricated PVDF/rGO/PEBAX/GO membranes was analyzed under scanning electron microscopy (SEM). As seen in FIG. 4A, two distinct regions were observed: an upper section representing the active (PEBAX/GO) layer 26 and a bottom section representing the (PVDF/rGO) support layer 24. The highly-magnified image of FIG. 4B of the support layer 24 revealed a porous structure under the dense active PEBAX/GO active layer 26. Increasing the rGO concentration in the support layer 24 from 0% to 0.5%, the porosity of the support layer 24 increased from about 73% to about 87% (FIG. 4B). It is believed that this may be because the hydrophilic nature due to —OH and —COOH increases when increasing the rGO concentration, and hence, the affinity towards the water (non-solvent) increases during the phase inversion processes. However, it was also noted that the increase in rGO concentration beyond 0.5% in the support layer 24 decreased the porosity of the membrane due to increased viscosity in casting solutions, thereby decreasing the water molecule affinity.

The investigations also showed that addition of the rGO fillers increased the thickness of the support layer 24. Because of the addition of rGO concentrations, the viscosity of the PVDF/rGO casting solution increased, thereby increasing the thickness when cast on the glass plate using the same amount of solutions. Table 1 below summarizes the thickness data of the fabricated PVDF/rGO/PEBAX/GO membranes with different rGO concentrations.

TABLE 1
Membrane thickness and porosity measurement of fabricated
membranes using SEM characterizations.

| | Support layer | Active layer |
|---|---|---|
| Sample | thickness (μm) | thickness (μm) |
| PVDF/rGO/000 | 94.26 ± 1.38 | 37.46 ± 3.27 |
| PVDF/rGO/025 | 139.35 ± 4.03 | 10.96 ± 2.19 |
| PVDF/rGO/050 | 236.79 ± 29.72 | 29.38 ± 2.95 |
| PVDF/rGO/075 | 307.09 ± 15.64 | 34.08 ± 3.19 |
| PVDF/rGO/100 | 358.76 ± 20.25 | 45.73 ± 4.63 |

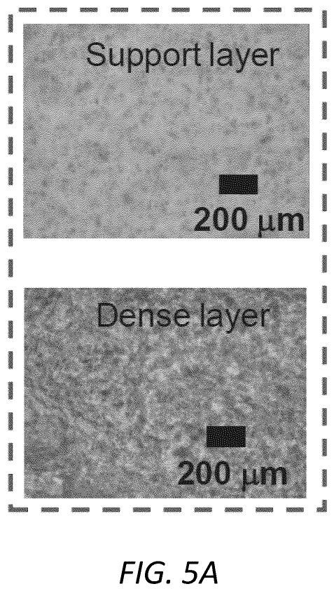

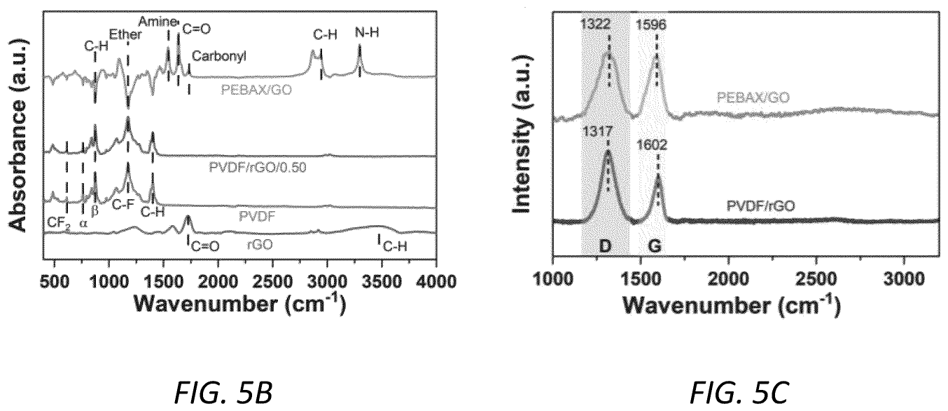

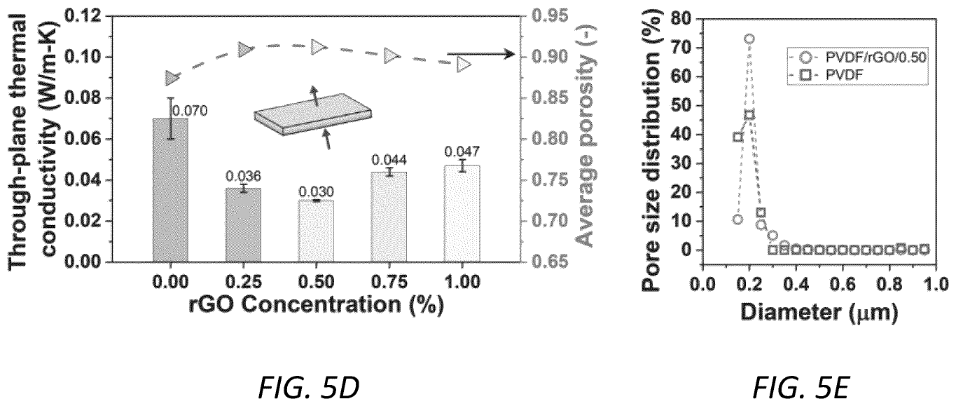

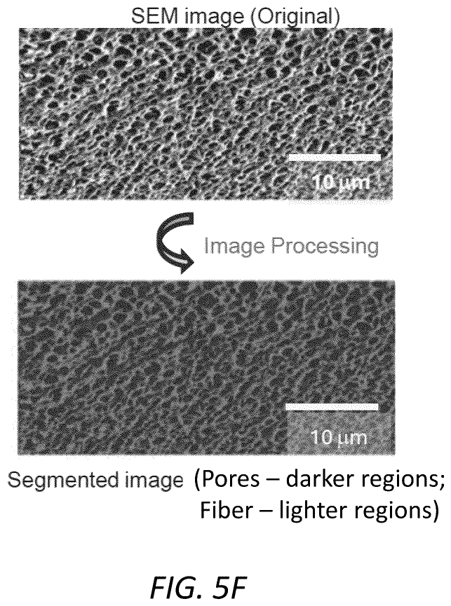

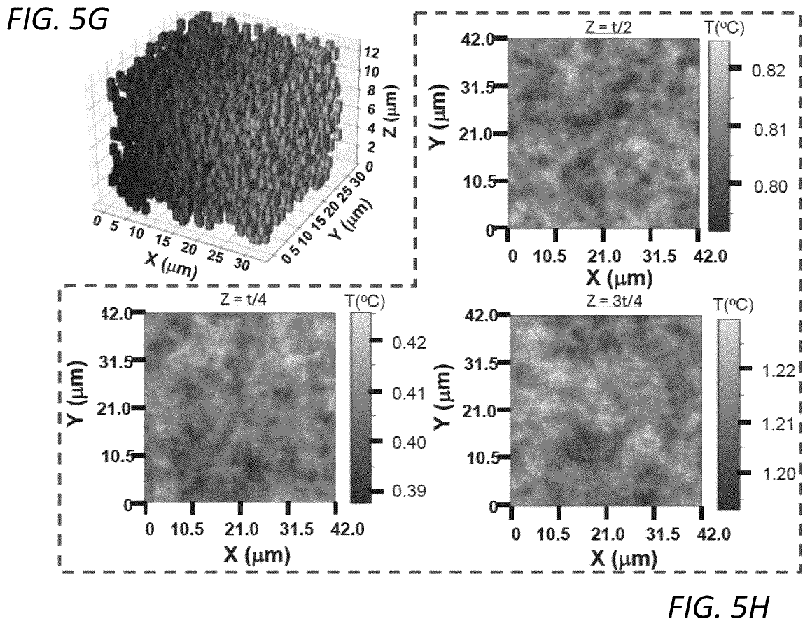

To determine different functional groups, Fourier transform infrared (FTIR) spectroscopy was performed on the membranes by varying the wavelength from 400 cm-1 to 4000 cm-1 (FIG. 5A). Absorbance data was recorded on several spots of rGO granules, support layers, and active layers. The functional groups CF₂, CF, and CH, in addition to a and β phases, were observed from the distinct peaks in PVDF support layer. For pure rGO, peaks were observed at wavelengths of about 3400 cm⁻¹ (O—H) and about 1730 cm⁻¹ (C—O). 8 However, for rGO grafted PVDF support layer, these peaks were suppressed. Similarly, for pure PEBAX/GO, the distinct carbonyl, ether, N—H, and C—O peaks were also obtained, and with the addition of rGO fillers in PVDF matrix, the peak intensity at those functional groups decreased.

As the investigations used carbon-based material in both the support layer (PVDF/rGO) and the active layer (PEBAX/GO), Raman spectroscopy can provide key insights into the presence of defects, as well as the bonding structure and crystallinity of the materials. Two fundamental vibrations or bands (D and G) can be observed from Raman spectroscopy for both the support and active layer (FIG. 5B). Peaks for the D band were observed at a wavelength of about 1322 cm⁻¹ and about 1317 cm⁻¹ for PEBAX/GO and PVDF/rGO, respectively. On the other hand, the G band peaks appeared at a wavelength of about 1596 cm⁻¹ for PEBAX/GO and about 1602 cm⁻¹ for PVDF/rGO. The D and G band intensity ratio (ID/IG) was much higher for PVDF/rGO than PEBAX/GO. This can be attributed to restoration of sp2 carbons and average size decrease of sp2 domains upon reduction of 02 molecules for PVDF/rGO.

The flat sheet support layers 24 were investigated using capillary flow porometry (CFP) to study the pore size and distributions (FIG. 5D). The mean flow pore size varied to 0.1993 μm, 0.227 μm, and 0.1809 μm for 0-0.5% rGO loading, respectively, as shown in Table 2 below. The investigations also showed that the total number of pores increases for the PVDF/rGO/050 support layer (FIG. 5E). It is believed this can be attributed to the affinity (hydrophilic nature) of the rGO towards water and increases the demixing process during the phase inversion method. It was also found that the number of pores increased up to 0.5% rGO concentration; however, above 0.5% rGO, the support layer pore numbers decreased, likely due to the increase in the viscosity of the casting solution.

TABLE 2
Tabulation of the support layer's mean
flow pore dia. and bubble point pore size

| | Mean flow | Bubble point |
|---|---|---|
| Sample ID | pore dia. (μm) | pore dia (μm) |
| PVDF/rGO/000 | 0.1993 | 1.4869 |
| PVDF/rGO/025 | 0.227 | 2.2064 |
| PVDF/rGO/050 | 0.1809 | 1.7127 |
| PVDF/rGO/075 | 0.2966 | 1.4539 |
| PVDF/rGO/100 | 0.9469 | 1.3502 |

The thermal conductivity of the porous support layer 24 was determined using two reference methods. The thermal conductivity of this porous support layer depends on the membrane's porosity and total number of pores. The investigations (FIG. 5C) showed that the thermal conductivity of the support layer decreases from 0.07 W/m-K to 0.03 W/m-K (close to air thermal conductivity of about 0.026 W/m-K) when the rGO loading in the support layer 24 increased from 0% (pure PVDF, PVDF/rGO/000) to 0.5% (PVDF/rGO/050). The observation is supported by the CFP test as the total number of pores appeared to have increased due to increased demixing. Furthermore, it was also evident that the porosity of the support layers 24 increased with the addition of rGO granules. However, above 0.5% rGO loading, the total number of pores in the support layer 24 decreased, and the through or cross-plane thermal conductivity of the support layers also started increasing correspondingly.

To understand the low thermal conductivity and porous structure of the membrane, a mechanistic modeling was developed using image processing and 3D Voronoi tessellation technique. From a cross-sectional SEM image of the insulating membrane, the fibers and pores were distinguished (FIG. 5F). By using the mean fiber and pore dimensions (obtained from the image processing technique), a 3-D Voronoi-based porous structure was generated to mimic the actual fiber and pore morphology of the fabricated membrane (FIG. 5G). To reduce the computational time and power, a domain of the membrane (42×42×19.4 μm³) was considered for determining the through-plane thermal conductivity. By imposing a constant boundary condition, the surface temperature distribution of the insulating membrane was obtained at different depths (FIG. 5H). The XY plane contour map suggested that the temperature is less in the darker regions (depicting the pores) than in the lighter regions (solid fibers). At different depths (z=t/4, t/2, 3t/4; t=thickness), the temperature varied based on the pores and fiber contents. By extending the similar analysis, the through-plane thermal conductivity of a membrane can be calculated. The obtained through-plane thermal conductivity was about 0.032 W/m-K, with an error of approximately 8% relative to the original value. By using the same Voronoi structure, the tortuosity of the insulating membrane was found to be about 1.35. Similarly, for the control membrane, the tortuosity of the membrane was determined to be about 1.2.

Water vapor permeance and the water vapor permeance with respect to air or N₂ gas permeance (selectivity) through the selective membrane 12 can significantly impact its dehumidification performance in the PMD system 10. The investigations showed that the average water vapor permeance decreased from 2799 GPU to 1755 GPU when the rGO loading varied from 0% (PVDF/rGO/PEBAX/GO/000) to 0.25% (PVDF/rGO/PEBAX/GO/025). Increasing the rGO loading increased the thickness and porosity of the support membrane 24 up to 0.5% concentrations. Increasing the thickness introduced more resistance to the water vapor removal, while on the other hand, the increase in porosity increased the water vapor permeance. These two counter-acting phenomena appear to determine the membrane water vapor permeance of different rGO loadings. It can be inferred that the thickness resistance is dominant up to 0.5% of rGO loading. Conversely, above 0.25% rGO loading, the water vapor permeance started increasing due to the porosity dominant effect. The N₂ permeance was initially higher for PVDF/rGO/PEBAX/GO/000; however, with the addition of rGO loading, the N₂ permeance decreased due to more hydrophilic fillers. Thus, the selectivity of the fabricated membranes followed the same trend as water vapor permeance.

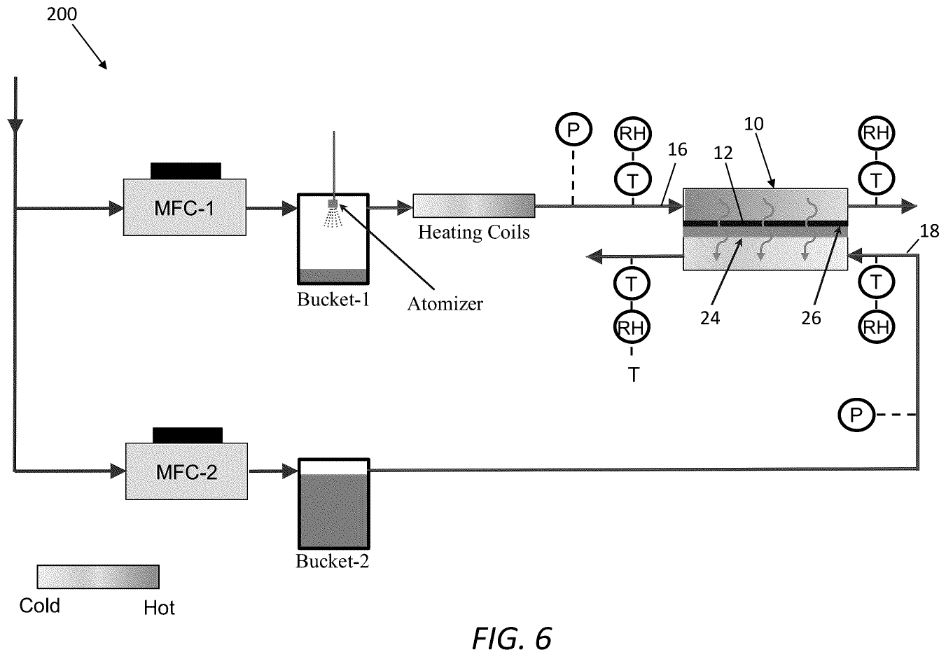

An experimental setup 200 of a membrane-based dehumidification system as shown in FIG. 6 {=FIG. 3a} was configured for conducting various investigations of the experimental passive membranes 12 relative to actual dehumidification performance in a membrane-based dehumidification system that incorporates the dehumidification module 10. In this experimental setup 200, compressed air having a pressure of 15 psi, temperature of 21° C., and relative humidity range between 2%-10% was used as the supply air (feed stream 16). The flow rates of both the feed stream 16 (top) and permeate stream 18 (bottom) were controlled using two mass flow controllers MFC-1 and MFC-2, respectively. The feed stream 16 from the MFC-1 entered a bucket where an atomizer sprayed water molecules into the feed air. This cold, humid air was then introduced into the heating coils to heat the feed stream 16. The hot, humid feed air stream 15 exiting the heating coils was then introduced into the dehumidification module 10 configured with the respective experimental selective membrane 12. The area (in-plane) dimensions of the active membrane were 160 mm×80 mm, and the channel dimensions (both feed and permeate side) of the membrane holder were 160 mm×80 mm×8 mm. The permeate air stream 18 from the MFC-2 entered a second stagnant water bucket, which added relatively low moisture content to the air stream. This cold, dry permeate air stream 18 then entered the other side (permeate side) of the membrane dehumidification module 10. The feed and permeate streams were configured in a counterflow arrangement moving in opposite directions across the opposite sides of the selective membrane 12 to ensure a high driving force for efficient dehumidification. Two pressure sensors were employed to measure the upstream pressure at both feed and permeate sides. Four relative humidity and temperature sensors were also used upstream and downstream of the feed and permeate flow stream.

In the investigations of the dehumidification performance of the experimental selective membranes 12 in the experimental setup 200, the experimental selective membranes 12 with no rGO concentration (PVDF/rGO/PEBAX/GO/000, thermal conductivity: 0.07 W/m-K) and lowest thermal conductivity (PVDF/rGO/PEBAX/GO/050, thermal conductivity: 0.03 W/m-K) were used as test specimens. The metrics used for comparing the performance of the membrane were the percentage of water removal (dehumidification performance DP) and latent effectiveness, which relates the water vapor pressure difference between the feed inlet and outlet to the maximum water vapor pressure difference between the feed inlet and permeate inlet.

The effect of change in relative humidity at constant temperature was investigated. These investigations showed that at constant temperature, the water vapor permeance increased with relative humidity. It is believed that this was due to sorption properties of PEBAX polymer and GO interlayer space variance with relative humidity.

In addition, the effect of change in temperature and relative humidity at a constant humidity ratio was investigated. For both membranes, the latent effectiveness increases with increased feed inlet temperature and constant humidity ratio. From 28° C. to 34° C., the latent effectiveness (ϵ_L) of the control membrane (PVDF/rGO/PEBAX/GO/000) was much higher than the thermally-insulating membranes (PVDF/rGO/PEBAX/GO/050). It can be inferred that the control membrane possesses higher water vapor permeance below 34° C. Water vapor permeance and permeate pressure increase are the two competing factors with the temperature. However, the thermally-insulating membrane performed much better when the temperature exceeded 34° C. This appears to have been due primarily to the thermally-insulating selective membranes 12 having high porosity and maintaining a high driving force by reducing the heat loss from the feed side to the permeate side.

Finally, the two membranes were compared under varying feed flow rate from 10 L/min to 30 L/min at a constant feed temperature and relative humidity (T=23° C. and RH=50%). As the flow rate increased (as does the Reynolds number), the feed stream spent less time in the membrane module and, therefore, exhibited a decreasing dehumidification performance. For example, the dehumidification performance of the control membrane decreased from 8.5% to 7% when the mass flow increased from 10 L/min to 25 L/min. At 30 L/min, the dehumidification performance or DP was almost the same as for 25 L/min. The same trend was also observed for the most-insulating membrane. However, the control membrane performed better in this test because it is thinner than the most-insulating membrane, making its diffusion resistance (at feed temperature lower than 34° C.) lower than that of the most-insulating membrane.

Based on these investigations, it can be seen that the addition of rGO fillers effectively increased the porosity and total number of pores in the PVDF matrix of the support layer 24, which resulted in a very low thermal conductivity of 0.03 W/m-K of the PVDF/rGO/050 support layer 24. Below 34° C., the control membrane performed better than the thermally-insulating membrane, apparently because the inherent high-water vapor permeance dominates the performance. However, above 34° C. the insulating membrane outperformed the control membrane, likely because the driving force became lower due to the heat loss from the permeate side. Some additional observations were that porosity and thickness appear to be two opposing factors determining the effective water vapor permeance for the membranes with varying rGO loadings. Under ambient conditions, the control test membrane performed better than the insulating test membrane. As the relative humidity increased, the latent effectiveness for both membranes increased.

As previously noted above, though the foregoing detailed description describes certain aspects of one or more particular embodiments of the invention, alternatives could be adopted by one skilled in the art. For example, the membrane-based dehumidification system, thermally-insulative selective membrane, and their components could differ in appearance and construction from the embodiments described herein and shown in the drawings, functions of certain components of the membrane-based dehumidification system and the thermally-insulative selective membrane could be performed by components of different construction but capable of a similar (though not necessarily equivalent) function, and various materials could be used in the fabrication of the membrane-based dehumidification system, thermally-insulative selective membrane, and/or their components. As particular examples, although polyvinylidene fluoride (PVDF) was used in the investigations, other polymers could be used, including but not limited to polytetrafluoroethylene (PTFE), polyacrylonitrile (PAN), polyethersulfone (PES), polysulfone (PSF), etc., and although a reduced graphene oxide filler was used in the investigations, other two-dimensional layered nanomaterial could be used, including but not limited to graphitic or graphene aerogels (GA), silica aerogels, graphene, and MXenes As such, and again as was previously noted, it should be understood that the invention is not necessarily limited to any particular embodiment described herein or illustrated in the drawings.

1. A membrane-based dehumidification system comprising:
a thermally-insulative selective membrane separating a feed stream of moist air to be dehumidified and a permeate stream of air, wherein water vapor partial pressure difference across the selective membrane urges water vapor in the feed stream to migrate across a thickness dimension of the selective membrane to the permeate stream, wherein the selective membrane comprises a porous thermally-insulating support layer and a hydrophilic active layer disposed on a side of the support layer, wherein the support layer comprises a mixture of:
polyvinylidene fluoride, polytetrafluoroethylene (PTFE), polyacrylonitrile (PAN), polyethersulfone (PES), and/or polysulfone (PSF); and
a two-dimensional layered nanomaterial filler chosen from the group consisting of a reduced graphene oxide, a graphitic or graphene aerogel (GA), a silica aerogel, graphene, and MXenes.

2. The membrane-based dehumidification system of claim 1, wherein the support layer comprises a mixture of polyvinylidene fluoride and reduced graphene oxide filler in an amount of about 0.25% to about 1% by weight relative to the polyvinylidene fluoride.

3. The membrane-based dehumidification system of claim 2, wherein the active layer comprises polyether-block-amide.

4. The membrane-based dehumidification system of claim 1, wherein the active layer faces the feed stream and the support layer faces the permeate stream.

5. The membrane-based dehumidification system of claim 4, wherein the active layer has a thickness of about 10 μm to about 50 μm and the support layer has a thickness of about 25 μm to about 360 μm.

6. The membrane-based dehumidification system of claim 1, wherein the system is a passive membrane dehumidification system.

7. A thermally-insulative selective membrane for a membrane-based dehumidification system, the selective membrane comprising:
a porous thermally-insulating support layer disposed on a side of a hydrophilic active layer, wherein the support layer comprises a mixture of:
polyvinylidene fluoride, polytetrafluoroethylene (PTFE), polyacrylonitrile (PAN), polyethersulfone (PES), and/or polysulfone (PSF); and
a two-dimensional layered nanomaterial filler chosen from the group consisting of a reduced graphene oxide, a graphitic or graphene aerogel (GA), a silica aerogel, graphene, and MXenes.

8. The thermally-insulative selective membrane of claim 7, wherein the support layer is hydrophobic.

9. The thermally-insulative selective membrane of claim 7, wherein the support layer comprises a mixture of polyvinylidene fluoride and reduced graphene oxide filler in an amount of about 0.25% to about 1% by weight relative to the polyvinylidene fluoride.

10. The thermally-insulative selective membrane of claim 7, wherein the active layer comprises polyether-block-amide.

11. The thermally-insulative selective membrane of claim 10, wherein the polyether-block-amide is Pebax-1657 available from Arkema France.

12. A method of using the thermally-insulative selective membrane of claim 7, the method comprising using the thermally-insulative selective membrane in a vacuum membrane dehumidification system, an energy recovery ventilator, or an industrial dryer.

13. A method of making a thermally-insulative selective membrane having an active layer and a support layer for a membrane-based dehumidification system, the method comprising:
forming the support layer from a first solution of:
polyvinylidene fluoride, polytetrafluoroethylene (PTFE), polyacrylonitrile (PAN), polyethersulfone (PES), and/or polysulfone (PSF); and
a two-dimensional layered nanomaterial filler chosen from the group consisting of a reduced graphene oxide, a graphitic or graphene aerogel (GA), a silica aerogel, graphene, and MXenes;
forming the active layer from a second solution comprising polyether-block-amide thermoplastic elastomer; and
securing the active layer to the support layer to form the thermally-insulative selective membrane such that the support layer provides structural support to the active layer.

14. The method of claim 13, wherein the first solution comprises the polyvinylidene fluoride and the reduced graphene oxide dissolved in a solvent.

15. The method of claim 14, wherein the first solution comprises 10% polyvinylidene fluoride and 0.25%-1% reduced graphene oxide dissolved in the solvent.

16. The method of claim 15, wherein the solvent is dimethylformamide.

17. The method of claim 13, wherein the second solution comprises the polyether-block-amide thermoplastic elastomer and graphene oxide dissolved in an aqueous-based solvent.

18. The method of claim 17, wherein the aqueous-based solvent comprises a water/ethanol mixture.

19. The method of claim 13, wherein forming the support layer comprises casting the first solution on a support surface, and wherein forming the active layer comprises casting the second solution directly onto the support layer to secure the active layer on the support layer.

20. The method of claim 19, further comprising drying the support layer before casting the second solution thereon.
